(19) United States
(12) Patent Application Publication
(10) Pub. No.: US 2021/0206386 A1
(43) Pub. Date: Jul. 8, 2021

(54) METHOD FOR CONTROLLING ELEMENTS OF A COCKPIT OF A VEHICLE AND ASSOCIATED DEVICES

(71) Applicants: FAURECIA INTERIEUR INDUSTRIE, Nanterre (FR); ZF FRIEDRICHSHAFEN AG, FRIEDRICHSHAFEN ALLEMAGNE (DE)

(72) Inventors: Didier PONTHIEU, LA NEUVILLE SAINT PIERRE (FR); Pierre GUERREIRO, MARGENCY (FR); Eric VANEL, NOVILLIERS (FR); Stéphane DA CRUZ, JOUY-SOUS-THELLE (FR); Frédéric BIGUET, BEAUMONT-SUR-OISE (FR); Olivier CENS, BETHENY (FR); Stefan KNOESS, FRIEDRICHSHAFEN ALLEMAGNE (DE); Guido HIRZMANN, FRIEDRICHSHAFEN ALLEMAGNE (DE); Lorenz GRAEFF, FRIEDRICHSHAFEN ALLEMAGNE (DE); Nicolas DAVIES, FRIEDRICHSHAFEN ALLEMAGNE (DE)

(21) Appl. No.: 17/140,106

(22) Filed: Jan. 3, 2021

(30) Foreign Application Priority Data
Jan. 3, 2020 (FR) FR 20 00030

(51) Int. Cl. B60W 50/14; B60W 50/08; B62D 1/181; B62D 1/183

(52) U.S. Cl. CPC B60W 50/14; B62D 1/183; B62D 1/181; B60W 50/082

(57) ABSTRACT

A method for controlling elements of a cockpit of a vehicle comprising a pedal, a seat, a steering system, and a controller, the steering system having a steering wheel and the vehicle being adapted to operate in manual driving and automatic driving modes. The method includes the steps of: obtaining parameters including the position of the driver in the seat, determining the positioning of the steering system based on the obtained parameters by maximizing the space allocated to the driver in the automatic driving mode while respecting a driving condition implying that the driver be able to reach the steering wheel and the pedal in a predetermined time period, and commanding the steering system to reach the determined positioning.

### FIELD OF THE INVENTION

The present invention concerns a method for controlling elements of a cockpit of a vehicle. The present invention also relates to a device for controlling elements of a cockpit of a vehicle, namely a controller. The present invention also concerns a steering system and a vehicle comprising the device. The present invention also relates to an associated computer program product and an associated computer-readable medium.

### BACKGROUND

Modern vehicles increasingly have assistance functions which permit a partially or completely automatic driving mode. Such system functions, which can relieve the driver of some of his tasks, or can facilitate these tasks, are also known as driver assistance systems. Examples which are known in motor vehicles include distance-based speed control systems, parking assistance systems, lane keeping assistance systems, braking assistance systems, and the like. Motor vehicles have already been publicly presented which have a completely automatic driving mode which therefore drive without the driver's involvement. Such a completely automatic driving mode is referred to from time to time in the prior art as automatic driving, autonomous driving or piloted driving.

Since the driver is relieved of some or of all of his driving tasks when the vehicle is in a partially or completely automatic driving mode, the driver can then assume a position of rest corresponding to the reduced number of tasks he has to perform. In particular, when the vehicle is operated in a completely automatic driving mode, the driver can assume a comfortable position of rest.

For this, it is known to move back the seat in the automatic driving which results in an increased roominess.

However, it is no longer possible to press the pedals of the vehicle or to reach the steering wheel correctly. Unsafe situations increase.

### SUMMARY

There is thus a need for a method for controlling elements of a cockpit of a vehicle providing an increased roominess in the automatic driving mode while providing with an improved safety.

To this end, the specification describes a method for controlling elements of a cockpit of a vehicle, the vehicle comprising a pedal, a seat, a steering system, and a controller, the steering system comprising a steering wheel, the vehicle being adapted to operate according to at least two driving modes, a manual driving mode and an automatic driving mode, the method being carried out by the controller, the method comprising a step of obtaining parameters, at least one of the obtained parameters is a parameter relative to the position of the driver in the seat, a step of determining the positioning of the steering system based on the obtained parameters by using an optimization technique. The optimization technique is carried out for maximizing the space allocated to the driver in the cockpit in the automatic driving mode while respecting at least one driving condition, a driving condition implying that the driver be able to reach the steering wheel and the pedal in a predetermined time period. The method for controlling further comprises a step of commanding the steering system to reach the determined positioning.

According to further aspects of the method which are advantageous but not compulsory, the method for controlling might incorporate one or several of the following features, taken in any technically feasible combination:
the parameter relative to the position of the driver in the seat is the hip point of the driver.
a low vision line is defined for the driver, another driving condition implying that the steering wheel be below the low vision line.
at the step of obtaining, the method comprises acquiring an image of the driver and obtaining a parameter relative to the morphology of the driver based on the acquired image, the parameter relative to the morphology of the driver being notably at least one of the arm's lengths and the shoulder positions.
the steering system further comprises a steering column, and, wherein, at the step of obtaining parameters, one obtained parameter is chosen in a group consisting of the tilt of the driver's seat, the position of the driver's seat, the position of the steering wheel, the position of the steering column.
the method further comprises determining the positioning of the driver's seat based on the obtained parameters by using an optimization technique, the optimization technique being carried out for maximizing the space allocated to the driver in the cockpit in the automatic mode while respecting at least one driving condition, a driving condition implying that the driver be able to reach the steering wheel and the pedal in a predetermined time period, and commanding the positioning of the driver's seat to reach the determined positioning.

The specification describes a controller configured for controlling elements of a cockpit of a vehicle, the vehicle comprising a pedal, a seat, a steering system, the steering system comprising a steering wheel, the vehicle being adapted to operate according to at least two driving modes, a manual driving mode and an automatic driving mode, the controller being configured to obtain parameters, at least one of the obtained parameters is a parameter relative to the position of the driver in the seat, to determine the positioning of the steering system based on the obtained parameters by using an optimization technique. The optimization technique is carried out for maximizing the space allocated to the driver in the cockpit in the automatic driving mode while respecting at least one driving condition, a driving condition implying that the driver be able to reach the steering wheel and the pedal in a predetermined time period. The controller is configured to command the steering system to reach the determined positioning.

The present specification also relates to an assembly comprising a steering system and a controller as previously described, the steering system comprising a steering adjustment unit configured to control the positioning of the steering system, the controller being configured to send the command to reach the determined positioning to the steering adjustment unit.

The specification also concerns a vehicle comprising a controller as previously described or an assembly as previously described.

The specification also describes a computer program product comprising computer program instructions, the computer program instructions being loadable into a data-processing unit and configured to cause execution of at least one step of the method for controlling as previously described when run by the data-processing unit.

The specification also relates to a computer-readable medium comprising computer program instructions which, when executed by a data-processing unit, cause execution of at least one step of the method for controlling as previously described.

### BRIEF DESCRIPTION OF THE DRAWINGS

The invention will be better understood on the basis of the following description which is given in correspondence with the annexed figures and as an illustrative example, without restricting the object of the invention. In the annexed figures:

FIG. 1 is a side view of part of an a cockpit of a vehicle with a driver,

FIG. 2 is a flowchart illustrating an example of carrying out of an example of a method for controlling elements of the cockpit.

### DETAILED DESCRIPTION

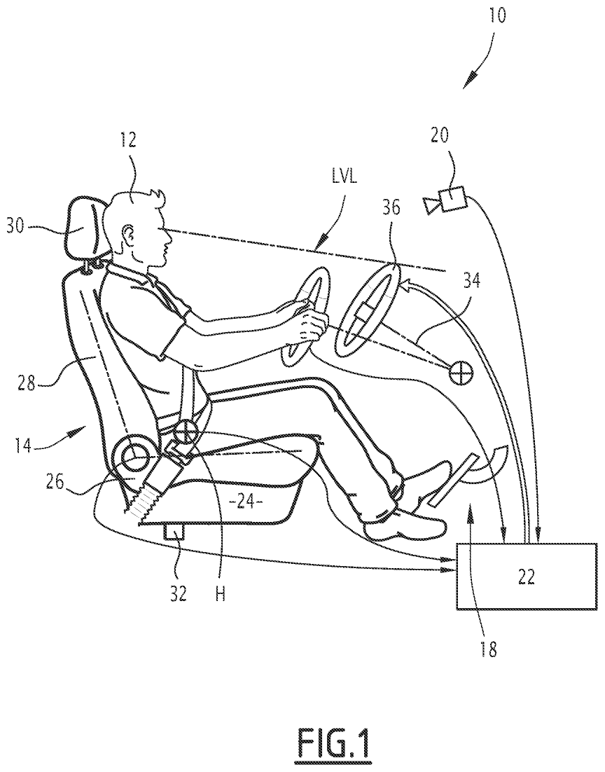

A cockpit 10 of a vehicle with a driver 12 is represented schematically on FIG. 1.

The vehicle is an automotive vehicle.

The vehicle is adapted to operate according to at least two driving modes M1 and M2.

The modes M1 and M2 can be defined with reference to the five levels of vehicle automation of the Society of Automotive Engineers (SAE).

The level 0 is the level in which the automated system issues warnings and may momentarily intervene but has no sustained vehicle control.

The level 1 is a level wherein the driver and the automated system share control of the vehicle. An example is the parking assistance, where steering is automated while speed is under manual control.

The level 2 is a level wherein the automated system takes full control of the vehicle (accelerating, braking, and steering). The driver must monitor the driving and be prepared to intervene immediately at any time if the automated system fails to respond properly.

In the level 3, the driver can safely turn his attention away from the driving tasks to watch a movie for instance. The vehicle will handle situations that call for an immediate response, like emergency braking. The driver must still be prepared to intervene within some limited time, specified by the manufacturer and/or by legislations, when called upon by the vehicle to do so.

Level 4 corresponds to the case of level 3 but no driver attention is ever required for safety in defined use cases. Self-driving is supported only in limited spatial areas or under special circumstances.

In level 5, no human intervention is required at all.

In the present case, the first mode M1 is the manual mode. This corresponds to levels 0 or 1 of the five levels of vehicle automation.

The second mode M2 is named the automatic driving mode. This second mode M2 corresponds to levels 2, 3 or 4 and more preferably to level 3.

The vehicle comprises a driver's seat 14, a steering system 16, a pedal 18, a camera 20 and a controller 22.

The driver's seat 14 comprises a seating part 24, a travel box 26, a backrest 28, a head restraint 30 and a seat sensor 32.

The seating part 24 is the part on which the driver 12 sits.

The travel box 26 enables the driver 12 to move the seating part 24 in two directions, the vertical one and the horizontal one. The vertical and horizontal directions are defined with relation to the normal operating of the vehicle.

The backrest 28 is the part on which the back of the driver 12 is supported.

The head restraint 30 is the part on which the head of the driver 12 relies on to prevent whiplash. The head restraint 30 is linked to the backrest 28.

The seat sensor 32 is adapted to provide to the controller 22 the angular position of the backrest 28 and the position of the seating part 24.

Alternatively, the angular position of the backrest 28 and the position of the seating part 24 are provided by a camera.

The steering system 16 comprises a steering column 34 and a steering wheel 36.

The angular position and the position of the steering column 34 and of the steering wheel 36 are adjustable by a steering adjustment unit which is not represented in FIG. 1 for the sake of simplicity.

Such steering adjustment unit is thus configured to control the positioning of the steering system 16.

The pedal 18 enables to control the speed of the vehicle.

The camera 20 is arranged to acquire images of facial image of the driver 12 and/or side images of the driver 12.

The controller 22 is an electronic control unit also named by its abbreviation ECU.

The controller 22 is configured to control each electronic equipment of the cockpit 10.

More generally, the controller 22 is a computer or computing system, or similar electronic computing device configured to manipulate and/or transform data represented as physical, such as electronic, quantities within the computing system's registers and/or memories into other data similarly represented as physical quantities within the computing system's memories, registers or other such information storage, transmission or display devices.

The controller 22 comprises a processor.

The processor comprises a data-processing unit, memories and a reader. The reader is configured to read a computer readable medium.

The computer program product comprises a computer readable medium.

The computer readable medium is a medium that can be read by the reader of the processor. The computer readable medium is a medium suitable for storing electronic instructions, and capable of being coupled to a computer system bus.

Such computer readable storage medium is, for instance, a disk, a floppy disks, optical disks, CD-ROMs, magnetic-optical disks, read-only memories (ROMs), random access memories (RAMs) electrically programmable read-only memories (EPROMs), electrically erasable and programmable read only memories (EEPROMs), magnetic or optical cards, or any other type of media suitable for storing electronic instructions, and capable of being coupled to a computer system bus.

A computer program is stored in the computer readable storage medium. The computer program comprises one or more stored sequence of program instructions.

The computer program is loadable into the data-processing unit and configured to cause execution of the method for determining when the computer program is run by the data-processing unit.

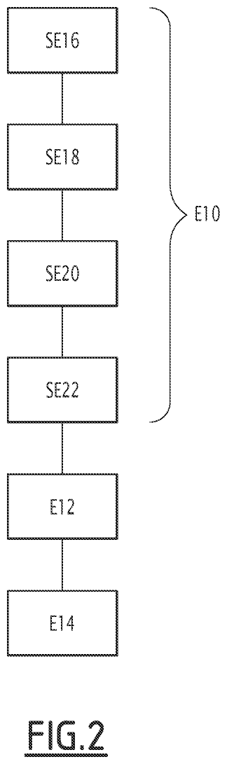

The operation of the vehicle, and more specifically the controller 22, is now described in reference to FIG. 2 which illustrates a flowchart corresponding to an example of carrying out a method for controlling elements of the cockpit 10.

In the present example, the elements controlled are the positions of the steering column 34 and of the steering wheel 36.

The method for controlling comprises a step of obtaining parameters E10, a step of determining E12 and a step of commanding E14.

In the present example, the step of obtaining parameters E10 comprises several substeps: a first substep SE16 of obtaining the morphology of the driver 12, a seond substep SE18 of obtaining the positioning of the driver's seat 14, a third substep SE20 of obtaining the position of the driver 12 in the seat 14 and a fourth substep SE22 of obtaining the positioning of the steering system 16.

During the first substep of obtaining SE16, elements of the morphology of the driver 12 are obtained.

Elements of the morphology includes the size of parts of the body of the driver 12 and the position of specific parts of the body of the driver 12.

For instance, the parts of the body are the legs, the arms, the shoulder and the head.

The first substep of obtaining SE16 can be carried out in several ways.

In a first way, the elements of the morphology of the driver 12 are provided directly to the controller 22.

In a second way, an image of the driver 12 with the camera 20 is acquired and the acquired image is exploited to obtain a parameter relative to the morphology of the driver 12.

Examples of parameters include arm lengths, the positions of the shoulders and the positions of the elbows.

During the second substep SE18 of obtaining, the positioning of the driver's seat 14 is obtained.

By “positioning” in this context, it is meant either the position of the driver's seat 14 or the tilt of the driver's seat 14.

In the present example, during the second substep SE18, it is obtained both the position and the tilt.

As an example, the position of the seat is the absolute position of one point of the seating part 24

The position of the seat 14 is a number based on the fact that the seat 14 is adapted to occupy a finite number of locations.

Similarly, the tilt of the seat 14 is provided by the absolute angle of the seat 14 or a number corresponding to the finite number of the inclination angles that can occupy the seat 14.

The second substep SE18 is, for instance, carried out by using the seat sensor 32.

Alternatively, the second substep SE18 is carried out by using a camera.

During the third substep SE20, the position of the driver 12 in the seat 14 is obtained.

According to the current example, the hip-point of the driver 12 is calculated.

The hip-point also named the H-point is the relative location of an occupant's hip: specifically the pivot point between the torso and upper leg portions of the body.

The hip-point is indicated by the reference sign H in FIG. 1.

The H-point is defined by European Standard ECE-R125.

In this European Standard, the H-point is determined based on the type of seat 14 used and notably the tilt of the driver's seat 14 and/or the seating part 24.

In the current example, the hip-point is determined based on an image acquired by the camera 20 and/or determined by the type of seat 14 used.

Alternatively or in addition, the parameter relative to the position of the driver 12 in the seat 14 is the low vision line LVL.

The low vision line LVL is defined by reference to the hip-point according to the following procedure which can be found in the previously mentioned European Standard.

In such case, the hip-point H is used to obtain a point representative of a mean position of the eye.

As a specific example, this point is the V2-point and is obtained by using standard dimensions of a mean driver as defined in the European Standard.

Then, a plane can be defined by three lines passing by the V2-point which are respectively named line 0°, line −1° and line −4°.

The European Standard then defines the position of the low vision line LVL in function of the three lines and in function of the size of the object to be reached.

In the present case, the low vision line is the line −1°.

In the illustrated method, the low vision line LVL is, for instance, determined based on an image acquired by the camera 20 which provides the size of the driver 12 and the hip-point H.

Alternatively, the V2-point is determined by using the camera 20 which enables to obtain a real position of the eye of the driver 12.

Alternatively the V2-point is determined only by the type of seat as described in the previously mentioned ECE-RE125 (in this case H-point is a theoretical point not related to the current driver)

During the fourth substep SE22, it is obtained at least one parameter of the positioning of the steering system 16 in the manual driving mode.

For instance, a parameter of the positioning of the steering system 16 is the position of the steering wheel 36 or the position of the steering column 34.

At the end of the step of obtaining E10, several parameters are obtained.

Alternatively, less parameters are obtained.

For instance, only a parameter relative to the position of the driver 12 in the seat in the manual driving mode is obtained.

During the step of determining E12, the positioning of the steering system 16 is determined based on the obtained parameters.

In such context, the positioning of the steering system 16 comprises the position of the steering wheel 36 and the position of the steering column 34.

The step of determining E12 is carried out by using an optimization technique.

The optimization technique is carried out for maximizing the space allocated to the driver 12 in the cockpit 10 in the automatic mode while respecting at least one driving condition.

In such example, a driving condition implies that the driver 12 be able to reach the steering wheel and the pedal in a predetermined time period.

In the step of determining E12, a reachable area is calculated, based on the morphology of the driver 12. This calculation allows determining a maximum position that is reachable by the driver 12 based on, for example, his arm length and/or his shoulder position.

This calculation can be performed in real time in order to be upgraded when the driver 12 moves in the seat 14.

Alternatively or in complement, a driving condition implies that the steering wheel 36 be below the low vision line LVL.

The optimization technique is, for instance, carried out with the following criteria:

keeping the steering wheel 36 at the furthest distance from the driver 12 and just tangent to the low vision line LVL. The optimization technique is supported by ergonomic studies which have determined how much clearance from the steering wheel 36 to the diver 12 is required.

In such optimization technique and also in others, it is to be noted that the movement of the steering wheel 36 can be any movement possible not limited in translation along one direction and rotation along one direction. For this, the steering wheel 36 can, for example, be mounted on a robot arm.

At the end of the determining step, an optimum position is determined for the steering system 16.

During the step of commanding, a command is sent to the steering wheel 36 and the steering column 34 to reach the determined optimum position.

More specifically, the controller 22 is configured to send the command to reach the determined positioning to the steering adjustment unit.

The method for controlling enables a new position of the steering wheel 36 and the steering column 34 to be obtained, the new position being adapted to offer more roominess for the driver 12 in automatic driving mode.

This position is adapted to the driver 12, notably to his morphology and his posture so as to ensure an immediate take over.

This means that the method provides an increased roominess in the automatic driving mode while providing with improved safety.

According to a specific embodiment, the method further comprises receiving the position of the seat 14, the steering wheel 36 and the steering column 34 in manual driving mode and storing this position as a reference position.

This enables to switch easily from the optimum position in the manual driving mode and the optimum position in the automatic driving mode M2.

According to a variant or in addition, during the determination, the positioning of the driver's seat 14 is another degree of freedom in addition to the positioning of the steering system 16.

This means that the optimum position which is determined comprises both the positioning of the driver's seat 14 and the positioning of the steering system 16.

The method further comprises commanding the positioning of the driver's seat 14 to reach the determined positioning.

In a variant, the method is carried out in real-time. This means that there are real-time detection and real-time displacement of the steering wheel 36.

In another embodiment, when the automatic driving mode M2 is activated, the movements of the seat 14 are blocked. The seat 14 cannot be moved anymore by the driver 12.

The method for controlling can correspond to any technically possible combination of the previously described embodiments.

1. A method for controlling elements of a cockpit of a vehicle, the vehicle comprising a pedal, a seat, a steering system, and a controller, the steering system comprising a steering wheel, the vehicle being adapted to operate according to at least two driving modes, a manual driving mode and an automatic driving mode, the method being carried out by the controller, the method comprising steps of:
obtaining parameters, at least one of the obtained parameters is a parameter relative to the position of the driver in the seat,
determining the positioning of the steering system based on the obtained parameters by using an optimization technique, the optimization technique being carried out for maximizing the space allocated to the driver in the cockpit in the automatic driving mode while respecting at least one driving condition, a driving condition implying that the driver be able to reach the steering wheel and the pedal in a predetermined time period, and
commanding the steering system to reach the determined positioning.

2. The method according to claim 1, wherein the parameter relative to the position of the driver in the seat is a hip point of the driver.

3. The method according to claim 1, wherein a low vision line is defined for the driver, another driving condition implying that the steering wheel be below the low vision line.

4. The method according to claim 1, wherein, at the step of obtaining, the method comprises acquiring an image of the driver and obtaining a parameter relative to the morphology of the driver based on the acquired image, the parameter relative to the morphology of the driver being at least one of the arm's lengths and the shoulder positions.

5. The method according to claim 1, wherein the steering system further comprises a steering column, and, wherein, at the step of obtaining parameters, one obtained parameter is chosen in a group consisting of the tilt of the driver's seat, the position of the driver's seat, the position of the steering wheel, and the position of the steering column.

6. The method according to claim 1, wherein the method further comprises:
determining the positioning of the driver's seat based on the obtained parameters by using an optimization technique, the optimization technique being carried out for maximizing the space allocated to the driver in the cockpit in the automatic mode while respecting at least one driving condition, a driving condition implying that the driver be able to reach the steering wheel and the pedal in a predetermined time period, and
commanding the positioning of the driver's seat to reach the determined positioning.

7. A controller configured for controlling elements of a cockpit of a vehicle, the vehicle comprising a pedal, a seat, a steering system, the steering system comprising a steering wheel, the vehicle being adapted to operate according to at least two driving modes, a manual driving mode and an automatic driving mode, the controller being configured to:
obtain parameters, at least one of the obtained parameters is a parameter relative to the position of the driver in the seat,
determine the positioning of the steering system based on the obtained parameters by using an optimization technique, the optimization technique being carried out for maximizing the space allocated to the driver in the cockpit in the automatic driving mode while respecting at least one driving condition, a driving condition implying that the driver be able to reach the steering wheel and the pedal in a predetermined time period, and
command the steering system to reach the determined positioning.

8. An assembly comprising a steering system and a controller according to claim 7, the steering system comprising a steering adjustment unit configured to control the positioning of the steering system, the controller being configured to send the command to reach the determined positioning to the steering adjustment unit.

9. A vehicle comprising an assembly according to claim 8.

10. A computer-readable medium having stored thereon computer program instructions which, when executed by the controller, cause execution of the steps of the method of claim 1.
